(19) United States
(12) Patent Application Publication
(10) Pub. No.: US 2017/0168364 A1
(43) Pub. Date: Jun. 15, 2017

(54) ELECTROCHROMIC GLAZINGS

(71) Applicant: SAGE ELECTROCHROMICS, INC., Faribault, MN (US)

(72) Inventors: Bryan D. GREER, Northfield, MN (US); Louis J. PODBELSKI, Eagan, MN (US); Helen E. SANDERS, Faribault, MN (US)

(21) Appl. No.: 15/373,817

(22) Filed: Dec. 9, 2016

Related U.S. Application Data
(60) Provisional application No. 62/265,661, filed on Dec. 10, 2015.

(51) Int. Cl. G02F 1/155

(52) U.S. Cl. CPC G02F 1/155; G02F 2001/1555

(57) ABSTRACT

A glazing can include a substrate having a viewable area contained within a boundary, and an electrochromic device coupled to the substrate. The electrochromic device can have a tintable area spaced apart from the boundary of the viewable area along at least 5% of the boundary. The tintable area can have a tintable surface area, A_{ED}, the viewable area of the substrate has a surface area, A_{VA}, and A_{ED} can be less than A_{VA}. A central portion of the viewable area can include a number of layers of material, a peripheral portion can include a number of layers of material, and the number of layers at the central portion can be greater than the number of layers at the peripheral portion.

### CROSS-REFERENCE TO RELATED APPLICATION(S)

This application claims priority under 35 U.S.C. §119(e) to U.S. Patent Application No. 62/265,661 entitled “ELECTROCHROMIC GLAZINGS,” by Bryan D. Greer, Louis J. Podbelski and Helen E. Sanders, filed Dec. 10, 2015, which is assigned to the current assignee hereof and incorporated herein by reference in its entirety.

### FIELD OF THE DISCLOSURE

The present disclosure relates to glazings, and more particularly to glazings including electrochromic devices.

### RELATED ART

Electrochromic glazings generally exhibit spectral transmission shifts as the glass transitions between bleached and tinted states. In the tinted state, light passing through the electrochromic typically appears blue as passage of non-blue spectral frequencies is diminished. Electrochromic glazings permitting a generally neutral spectrum of daylight illumination without any pronounced hue while in the tinted state are desired.

### BRIEF DESCRIPTION OF THE DRAWINGS

Embodiments are illustrated by way of example and are not intended to be limited in the accompanying figures.

FIG. 1 includes a cross-sectional view of a glazing including a substrate and an electrochromic device in accordance with an embodiment.

FIG. 2 includes a cross-sectional view of a glazing including a substrate and an electrochromic device in accordance with an embodiment.

FIG. 3 includes an elevation view of the glazing as seen from a major surface of the glazing in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass and electrochromic arts.

In accordance with one or more embodiments described herein, a glazing can include a substrate having a viewable area contained within a boundary. An electrochromic device can be coupled to the substrate and have a tintable area spaced apart from the boundary of the viewable area along at least 5% of the boundary. In an embodiment, the tintable area can be spaced apart from the boundary of the viewable area along at least 10% of the boundary, along at least 25% of the boundary, along at least 50% of the boundary, along at least 75% of the boundary, or along the entire boundary. The configuration of the electrochromic device relative to the viewable area may permit transmission of a neutral spectrum of daylight illumination without any pronounced hue while simultaneously providing suitable shading.

FIG. 1 includes a cross-sectional view of a substrate 100 and an electrochromic device 102 coupled to the substrate 100. The substrate 100 has major surfaces 104 and 106. The substrate 100 can be transparent or translucent. In an embodiment, the substrate 100 can include a glass substrate, a sapphire substrate, an aluminum oxynitride (AlON) substrate, a spinel substrate, or a transparent polymer. The transparent polymer can include a polyacrylate, a polyester, a polycarbonate, a polysiloxane, a polyether, a polyvinyl compound, another suitable class of transparent polymer, or a mixture thereof. In another embodiment, the substrate 102 can be a laminate including layers of the materials that make up the previously described substrates. In an embodiment, the substrate 100 can be a glass substrate that can include SiO₂ and one or more other oxides. Such other oxides can include Al₂O₃, an oxide of an alkali metal, an oxide of an alkaline earth metal, B₂O₃, ZrO₂, P₂O₅, ZnO, SnO₂, SO₃, As₂O₂, or Sb₂O₃. The substrate 100 may include a colorant, such as oxides of iron, vanadium, titanium, chromium, manganese, cobalt, nickel, copper, cerium, neodymium, praseodymium, or erbium, or a metal colloid, such as copper, silver, or gold, or those in an elementary or ionic form, such as selenium or sulfur.

In a particular instance, the glass substrate may be at least 50 wt % SiO₂. In an embodiment, the SiO₂ content may be in a range of 50 wt % to 85 wt %. Al₂O₃ may help with scratch resistance, for example, when the major surface 104 is along an exposed surface of the substrate 100 being formed. When present, Al₂O₃ content can be in a range of 1 wt % to 20 wt %. B₂O₃ can be usefully used to reduce both the viscosity of the glass and its thermal expansion coefficient. The B₂O₃ content may be no greater than 20 wt %, and in a particular embodiment, less than 15 wt %. Alkaline earth metals include magnesium, calcium, strontium, and barium. The oxides of an alkaline earth metal are useful for reducing the viscosity of the glass and facilitating fusion, without heavily penalizing the expansion coefficient. Calcium and magnesium have a relatively low impact on the density of the glass as compared to some of the other oxides. In large quantities, however, they could promote the devitrification of the glass. The total content of alkaline metal oxide may be no greater than 25 wt %, 20 wt %, or 15 wt %. Oxides of an alkali metal can reduce viscosity of the glass substrate and its propensity to devitrify. A drawback of alkali metal oxides is a significant increase in the thermal expansion coefficient. The total content of alkali metal oxides may be no greater than 8 wt %, 6 wt %, or 5 wt %. In some applications, the glass substrate is desired to be clear, and thus, the content of colorants is low. In a particular embodiment, the iron content is less than 200 ppm.

In an embodiment, the substrate 100 can include heat-strengthened glass, tempered glass, partially heat-strengthened or tempered glass, or annealed glass. “Heat-strengthened glass” and “tempered glass”, as those terms are known in the art, are both types of glass that have been heat treated to induce surface compression and to otherwise strengthen the glass. Heat-treated glasses are classified as either fully tempered or heat-strengthened. In an embodiment, the glass substrate is tempered glass and has a surface compression of about 69 MPa or more and an edge compression of about 67 MPa or more. In another embodiment, the transparent substrate is heat-strengthened and has a surface compression in a range of 24 MPa to 69 MPa and an edge compression between 38 MPa and 67 MPa. The term “annealed glass” means glass produced without internal strain imparted by heat treatment and subsequent rapid cooling. Thus annealed glass only excludes heat-strengthened glass or tempered glass. The substrate 100 can be laser cut. For example, in an embodiment, a laser may first inscribe the substrate 100 along a predetermined path. The substrate 100 may then be mechanically separated along the predetermined path.

The thickness of the substrate 100 may depend on the desired application (e.g., residential architectural window, commercial architectural window, or another application) and desired thermal/structural properties. The substrate 100 can have a thickness in a range of 1.0 mm to 25 mm. In a particular embodiment, the substrate 100 has a thickness in a range of 2 mm to 15 mm.

In a particular embodiment, the substrate 100 can have a relative large area along the major surfaces 104 and 106. In an embodiment, the substrate 100 may not be processed in a vapor deposition tool, and therefore, is not restricted by the size of a deposition chamber of the vapor deposition tool. Along either or both major surfaces, a substrate can be in the shape of a rectangle, triangle or another polygon, a circle, an ellipse, oblong, or another suitable shape. In the embodiment as illustrated, the substrate 100 can have a length of at least 0.5 m, at least 1.0 m, at least 1.5 m, at least 2.0 m, or even longer, and a width at least 0.5 m, at least 1.0 m, at least 1.5 m, at least 2.0 m, or wider.

In an embodiment, the substrate 100 and electrochromic device 102 may be coupled together by an adhesive, such as an adhesive film. The adhesive film can include a polyvinyl butyral, polyvinyl acetate, polyurethane, another suitable adhesive, or any mixture thereof. The adhesive film may have a thickness of no greater than 3 mm, no greater than 2 mm, or no greater than 1 mm. The adhesive film can have substantially a real dimensions or trimmed to substantially the same a real dimensions as the electrochromic device 102. For example, substantially the same a real dimensions can be within 5%, 3%, or 1% of each other. In another embodiment, the electrochromic device 102 may be additively positioned on the substrate 100. For example, the electrochromic device 102 may be deposited on the substrate 100 to form a coating or layer. One or more intermediate layers may be disposed between the substrate 100 and the electrochromic device 102.

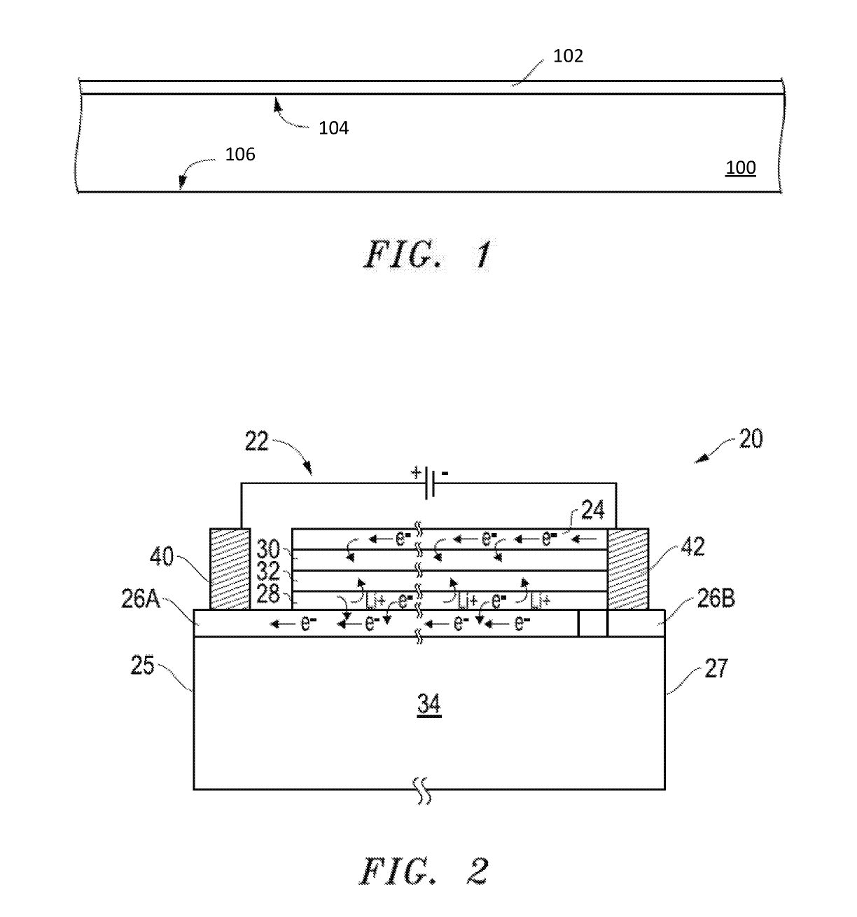

Referring to FIG. 2, the electrochromic device can include isolated transparent conductive layer regions 26A and 26B, a counter electrode layer 28, a solid ion conductive layer 32, an electrochromic layer 30 and a transparent conductive layer 24. The layers 26, including regions 26A and 26B, 28, 30, 32, and 24 can be vapor deposited. In another embodiment, the relative positions of the electrochromic layer 30 and the counter electrode layer 28 may be interchanged. Further, the device 20 can includes a bus bar 40 which is in contact only with the conductive layer region 26A, and a bus bar 42 which may be formed on the conductive layer region 26B and is in contact with the conductive layer 24. The bus bars 40 and 42 can be formed by printing a conductive ink or using another technique. The voltage source 22 and wires connected to the bus bars 40 and 42 may or may not be part of the panel.

When the voltage source 22 is operated to apply an electrical potential across the bus bars 40, 42, electrons, and thus a current, flows from the bus bar 42, across the transparent conductive layer 24 and into the electrochromic layer 30. Further, ions flow from the counter electrode layer 28, through the ion conductive layer 32, and to the electrochromic layer 30, and a charge balance is maintained by electrons being extracted from the counter electrode layer 28, and then being inserted into the electrochromic layer 30 via the external circuit. The above-described electrochromic device may be a solid state device.

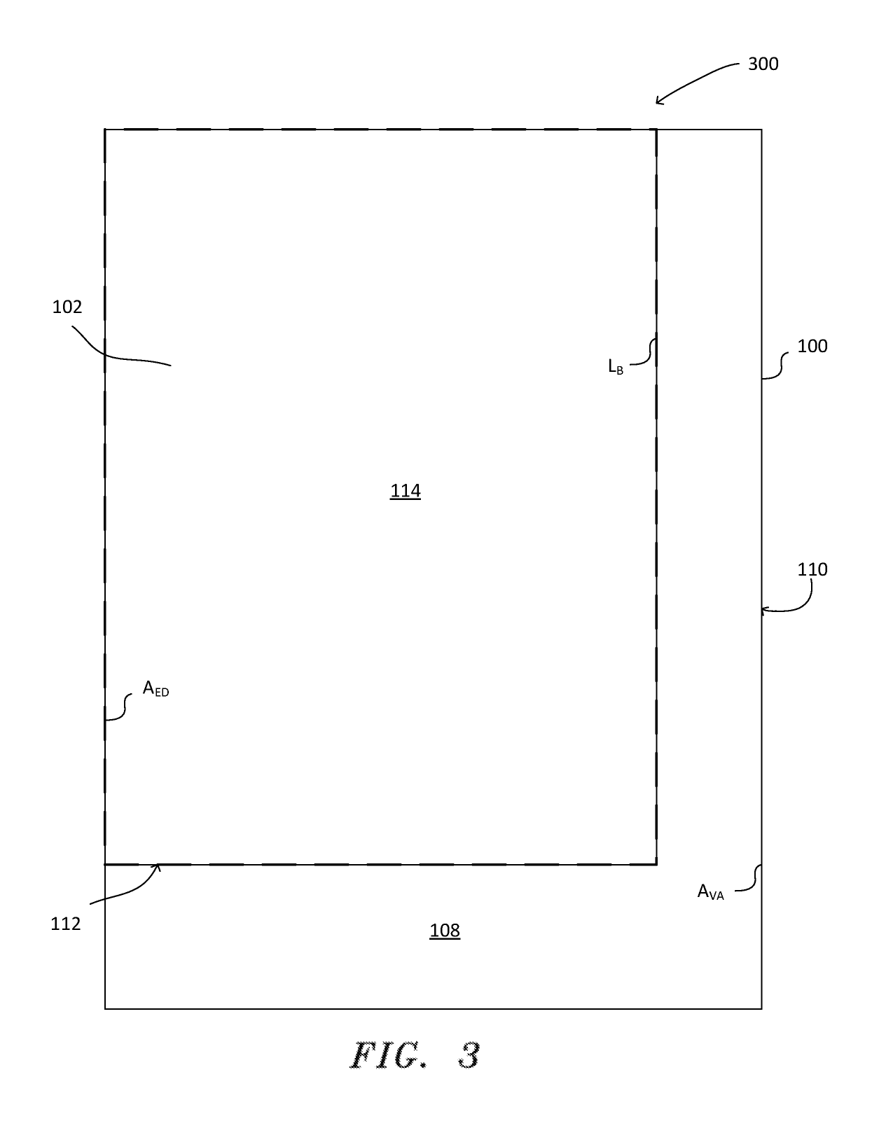

Referring to FIG. 3, a glazing 300 may include the substrate 100 and the electrochromic device 102. In a particular embodiment, the glazing is free, or substantially free, of a second electrochromic device. That is, the electrochromic device 102 is the only, or substantially only, electrochromic device positioned on the substrate 100.

The substrate 100 defines a viewable area 108 contained within a boundary 110. Light may pass through the viewable area 108. The boundary 110 may be defined by one or more frames or objects which secure the glazing 300 to a surface, such as a wall or ceiling. Light may not pass through the glazing 300 at locations external to the viewable area 108. The electrochromic device 102 may be coupled at least partially within the viewable area 108. In an embodiment, a majority, such as all, of the electrochromic device 102 is disposed within the viewable area 108.

The electrochromic device 102 includes a tintable area 114 which can transition between bleached and tinted states. The tintable area can define a border 112. In an embodiment, at least a portion of the border 112 of the tintable area 114 may be spaced apart from a portion of the boundary 110. For example, the tintable area 114 can be spaced apart from the boundary 110 along at least 5% of the boundary, along at least 10% of the boundary, along at least 25% of the boundary, along at least 50% of the boundary, or along at least 75% of the boundary. In a particular embodiment, the tintable area 114 can be entirely spaced apart, i.e., 100% spaced apart, from the boundary 110. In an embodiment, at least a portion of the border 112 of the tintable area 114 can be spaced apart from the boundary 110 by a distance of at least 0.5 cm, at least 0.75 cm, at least 1 cm, at least 2 cm, at least 3 cm, at least 4 cm, at least 5 cm, or at least 10 cm. In a further embodiment, a majority of the border 112 can be spaced apart from the boundary 110 by a distance of at least 0.5 cm, at least 0.75 cm, at least 1 cm, at least 2 cm, at least 3 cm, at least 4 cm, at least 5 cm, or at least 10 cm. In yet another embodiment, the entire border 112 can be spaced apart from the boundary 110 by a distance of at least 0.5 cm, at least 0.75 cm, at least 1 cm, at least 2 cm, at least 3 cm, at least 4 cm, at least 5 cm, or at least 10 cm. In an embodiment, no portion of the border 112 is spaced apart from the boundary 110 by a distance of greater than 1000 cm, greater than 100 cm, greater than 50 cm, or greater than 10 cm.

In a particular embodiment, the distance between the border 112 and the boundary 110 may be uniform, or generally uniform, at locations where the border 112 and boundary 110 are spaced apart from one another. As used herein, “generally uniform” refers to a relative variation of less than 5%, less than 4%, less than 3%, or less than 2% as measured between two locations. In another particular embodiment, the distance between the border 112 and the boundary 110 may vary at locations where the border 112 and boundary 110 are spaced apart. For example, the border 112 and boundary 110 may be spaced apart by a first distance at a first location and a second distance at a second location, where the first and second distances are different from one another. By way of a non-limiting example, the first distance may be at least 106% the second distance, at least 107% the second distance, at least 108% the second distance, at least 109% the second distance, at least 110% the second distance, at least 125% the second distance, at least 150% the second distance, or at least 200% the second distance. The varying distance between the border 112 and boundary 110 may be incremental, undulating, castellated, or random. As will be described in greater detail below, the tintable area may include a plurality of side segments defining the border 112. At least a portion of at least one of the side segments is spaced apart from the boundary 110.

In certain embodiments, the tintable area 114 may have a tintable surface area, A_{ED}, that is less than the total surface area, A_{VA}, of the viewable area 108. In a particular embodiment, the tintable surface area is defined by the tintable area 114 contained within the boundary 110. Viewable area 108 not including portions of the tintable area 114 may permit transmission of a full, or nearly full, spectrum of visible light through the glazing 200 while the electrochromic device 102 is in both the tinted and bleached states. Inclusion of such area in the viewable area 108 may permit transmission of a generally neutral spectrum of daylight illumination while reducing total light transmission through the glazing 200 without any pronounced hue. In an embodiment, A_{VA} may be at least 1.01 A_{ED}, at least 1.05 A_{ED}, at least 1.1 A_{ED}, at least 1.15 A_{ED}, at least 1.2 A_{ED}, at least 1.25 A_{ED}, at least 1.3 A_{ED}, at least 1.35 A_{ED}, at least 1.4 A_{ED}, at least 1.45 A_{ED}, or at least 1.5 A_{ED}. In a further embodiment, A_{VA} may be no greater than 100 A_{ED}.

The electrochromic device 102, particularly the tintable area 114, may include a number of layers of material, such as for example, at least three layers, at least four layers, at least five layers, or even at least six layers. The substrate 100 may include a number of layers of material. In an embodiment, a central portion of the glazing, as measured in the viewable area 108, may include a number of layers of material that is different from a number of layers at a peripheral portion of the glazing. The peripheral portion may extend around an entire periphery of the viewable area 108 adjacent to the boundary 110 or along only a portion thereof. Moreover, the peripheral portion may vary in width as measured at different locations along the glazing 200.

In a particular instance, the number of layers of material at the central portion of the glazing 200 may be greater than the number of layers at the peripheral portion. As used herein, a “layer” is defined as a discrete, or distinct stratus of material which is discernably different from another stratus of material adjacent thereto. Certain materials, such as the substrate 100 may include one discernable layer having a generally homogenous composition. The electrochromic device 102 may include one or more discernable layers. The combination thereof may thus include at least two layers.

As described above, the tintable area 114 can include a plurality of side segments. For example, the tintable area 114 can include at least three side segments, at least four side segments, at least five side segments, or even at least ten side segments. In a particular embodiment, the border 112 can have a generally rectangular shape defining four side segments. The side segments can be arcuate, polygonal, or a combination thereof with each pair of adjacent side segments meeting at a junction having an internal angle.

In an embodiment, the tintable area 114 has a border length, L_{B}, as measured around an outermost edge, and at least 1% of L_{B} is arcuate. In a further embodiment, at least 10% of L_{B} is arcuate, at least 25% of L_{B} is arcuate, at least 50% of L_{B} is arcuate, at least 75% of L_{B} is arcuate, or at least 99% of L_{B} is arcuate. In another embodiment, at least 1% of L_{B} lies along one or more straight line segments, at least 5% of L_{B} lies along one or more straight line segments, at least 10% of L_{B} lies along one or more straight line segments, at least 25% of L_{B} lies along one or more straight line segments, at least 50% of L_{B} lies along one or more straight line segments, at least 75% of L_{B} lies along one or more straight line segments, or at least 99% of L_{B} lies along one or more straight line segments.

At least 1% of L_{B} can be spaced apart from the boundary 110. In an embodiment, at least 5% of L_{B} is spaced apart from the boundary 110, at least 10% of L_{B} is spaced apart from the boundary 110, at least 25% of L_{B} is spaced apart from the boundary 110, or at least 150% of L_{B} is spaced apart from the boundary 110. In another embodiment, no greater than 99% of L_{B} is spaced apart from the boundary, or no greater than 75% of L_{B} is spaced apart from the boundary. In yet a further embodiment, 100% of L_{B} is spaced apart from the boundary.

The substrate 100 can also include a plurality of side segments defined by the boundary 108. For example, the substrate 100 can include at least three side segments, at least four side segments, at least five side segments, or at least ten side segments. The side segments of the substrate 100 can include, but are not limited to, an upper side segment, a lower side segment, a left side segment, and a right side segment. Each of the side segments can have a polygonal shape, an arcuate shape, or a combination thereof.

In a particular embodiment, at least one of the side segments can lie along a straight line. In another particular embodiment, at least one of the side segments can be arcuate. One or more intermediary segments can extend between adjacent side segments. For example, an intermediary segment can extend between the upper side segment and the left side segment. The intermediary segment can extend at any relative angle with respect to the side segments and may be polygonal, arcuate, or a combination thereof.

The border 112 of the tintable area 114 can include a straight side segment extending along a first line and the boundary 110 of the viewable area 108 can include at least one straight side segment extending along a second line. In a particular embodiment, the first and second lines can intersect one another.

In an embodiment, the tintable area 114 can be at least partially spaced apart from at least one of the side segments of the substrate 100. In a particular instance, the tintable area 114 can be spaced apart from at least a portion of at least one of the upper, lower, left, and right side segments. In a further embodiment, the tintable area 114 can be spaced apart from at least two of the upper, lower, left, and right side segments. The at least two side segments can be adjoining side segments, such as the upper and right side segments, or opposing side segments, such as the upper and lower side segments. The distance between the tintable area 114 and the at least two side segments can be uniform, or substantially uniform. Alternatively, the different side segments can be spaced apart from the tintable area 114 by different distances. In an embodiment, the tintable area 114 can be spaced apart from at least 10% of at least one of the at least three side segments of the substrate 100, at least 20% of at least one of the at least three side segments, at least 30% of at least one of the at least three side segments, at least 40% of at least one of the at least three side segments, at least 50% of at least one of the at least three side segments, at least 75% of at least one of the at least three side segments, or at least 99% of at least one of the at least three side segments. In another embodiment, the tintable area 114 can be entirely spaced apart from at least one of the at least three side segments of the substrate 100, at least two of the at least three side segments, or at least three of the at least three side segments. This can occur when no portion of the side segment of the substrate 100 contacts or overlaps any side segment of the tintable area.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the embodiments as listed below.

Embodiment 1. A glazing comprising:
a substrate having a viewable area contained within a boundary; and
an electrochromic device coupled to the substrate,
wherein the electrochromic device has a tintable area spaced apart from the boundary of the viewable area along at least 5% of the boundary, along at least 10% of the boundary, along at least 25% of the boundary, along at least 50% of the boundary, along at least 75% of the boundary, or along 100% of the boundary.

Embodiment 2. A glazing comprising:
a substrate having a viewable area contained within a boundary; and
an electrochromic device coupled to the substrate,
wherein the electrochromic device has a tintable surface area, A_{ED}, as defined by a tintable area contained within the boundary of the viewable area, the viewable area of the substrate has a surface area, A_{VA}, and wherein A_{ED} is less than A_{VA}.

Embodiment 3. A glazing comprising:
a substrate having a viewable area contained within a boundary; and
an electrochromic device coupled to the substrate;
wherein a central portion of the viewable area comprises a number of layers of material, wherein a peripheral portion, adjacent to the boundary, comprises a number of layers of material, and wherein the number of layers at the central portion is greater than the number of layers at the peripheral portion.

Embodiment 4. A glazing comprising:
a substrate having a viewable area contained within a boundary, wherein the boundary defines an upper side segment, a lower side segment, a left side segment, and a right side segment; and
an electrochromic device coupled to the substrate and having a tintable area spaced apart from at least one of the upper, lower, left, and right side segments.

Embodiment 5. A glazing comprising:
a substrate having a viewable area contained within a boundary; and
an electrochromic device coupled to the substrate,
wherein a tintable area of the electrochromic device is contained entirely within the viewable area, wherein the tintable area is adapted to transition between a bleached state and a tinted state, and wherein in each of the bleached and tinted states all of tintable area has a substantially uniform characteristic.

Embodiment 6. An electrochromic device adapted for use with a glazing, the electrochromic device comprising:
an electrochromic stack having a tintable area, A_{ED},
wherein A_{ED} is less than a viewable area of the glazing, A_{VA}.

Embodiment 7. The glazing or electrochromic device of any one of the preceding embodiments, wherein at least a portion of a border of the tintable area is spaced apart from the boundary of the viewable area by a distance of at least 0.5 cm, at least 0.75 cm, at least 1 cm, at least 2 cm, at least 3 cm, at least 4 cm, or at least 5 cm.

Embodiment 8. The glazing or electrochromic device of any one of the preceding embodiments, wherein an entire border of the tintable area is spaced apart from the boundary of the viewable area by a distance of at least 0.5 cm, at least 0.75 cm, at least 1 cm, at least 2 cm, at least 3 cm, at least 4 cm, or at least 5 cm.

Embodiment 9. The glazing or electrochromic device of any one of the preceding embodiments, wherein at least a portion of a border of the tintable area is spaced apart from the boundary of the viewable area by a distance no greater than 100 cm, no greater than 50 cm, or no greater than 10 cm.

Embodiment 10. The glazing or electrochromic device of any one of the preceding embodiments, wherein an entire border of the tintable area is spaced apart from the boundary of the viewable area by a distance of no greater than 100 cm, no greater than 50 cm, or no greater than 10 cm.

Embodiment 11. The glazing or electrochromic device of any one of embodiments 7-10, wherein the distance between the border of the tintable area and the boundary of the viewable area is generally uniform as measured around the boundary of the viewable area.

Embodiment 12. The glazing or electrochromic device of any one of embodiments 7-11, wherein the distance between the border of the tintable area and the boundary of the viewable area is uniform as measured around the boundary of the viewable area.

Embodiment 13. The glazing or electrochromic device of any one of embodiments 7-10, wherein the distance between the border of the tintable area and the boundary of the viewable area comprises a first distance at a first location of the glazing and a second distance at a second location of the glazing, and wherein the first distance is different than the second distance.

Embodiment 14. The glazing or electrochromic device of embodiment 13, wherein the first distance is greater than the second distance.

Embodiment 15. The glazing or electrochromic device of any one of embodiments 13 and 14, wherein the first distance is at least 101% the second distance, at least 102% the second distance, at least 103% the second distance, at least 104% the second distance, at least 105% the second distance, at least 110% the second distance, or at least 125% the second distance.

Embodiment 16. The glazing or electrochromic device of any one of embodiments 2-15, wherein the border of the tintable area is spaced apart from a boundary of the viewable area along at least 5% of the border of the tintable area, along at least 10% of the border of the tintable area, along at least 25% of the border of the tintable area, along at least 50% of the border of the tintable area, along at least 75% of the border of the tintable area, or along at least 99% of the border of the tintable area.

Embodiment 17. The glazing or electrochromic device of any one of embodiments 1 and 3-16, wherein the tintable area has a tintable surface area, A_{ED}, as defined by a tintable area contained within the boundary of the viewable area, the viewable area of the substrate has a surface area, A_{VA}, and wherein A_{ED} is less than A_{VA}.

Embodiment 18. The glazing or electrochromic device of any one of embodiments 2 and 17, wherein A_{VA} is at least 1.01 A_{ED}, at least 1.05 A_{ED}, at least 1.1 A_{ED}, at least 1.15 A_{ED}, at least 1.2 A_{ED}, at least 1.25 A_{ED}, at least 1.3 A_{ED}, at least 1.35 A_{ED}, at least 1.4 A_{ED}, at least 1.45 A_{ED}, or at least 1.5 A_{ED}.

Embodiment 19. The glazing or electrochromic device of any one of embodiments 1, 2, and 4-18, wherein a central portion of the viewable area comprises a number of layers of material, wherein a peripheral portion, adjacent to the boundary, comprises a number of layers of material, and wherein the number of layers at the central portion is greater than the number of layers at the peripheral portion.

Embodiment 20. The glazing or electrochromic device of any one of embodiments 3 and 19, wherein the central portion has at least 1 more layer than the peripheral portion, at least 2 more layers than the peripheral portion, at least 3 more layers than the peripheral portion, at least 4 more layers than the peripheral portion, or at least 5 more layers than the peripheral portion.

Embodiment 21. The glazing or electrochromic device of any one of embodiments 1-4 and 6-20, wherein the tintable area is adapted to transition between a bleached state and a tinted state, and wherein in each of the bleached and tinted states all of tintable area has a substantially uniform characteristic.

Embodiment 22. The glazing or electrochromic device of any one of the preceding embodiments, wherein the electrochromic device comprises:
an electrochromic layer;
a counter electrode layer; and
an ion conductive layer disposed between the electrochromic layer and the counter electrode layer.

Embodiment 23. The glazing or electrochromic device of any one of the preceding embodiments, wherein the electrochromic device is a solid state device.

Embodiment 24. The glazing or electrochromic device of any one of the preceding embodiments, wherein the substrate comprises glass or an optical glazing.

Embodiment 25. The glazing or electrochromic device of any one of the preceding embodiments, wherein the substrate is translucent, wherein the substrate is transparent.

Embodiment 26. The glazing or electrochromic device of any one of the preceding embodiments, wherein the tintable area comprises a border having a polygonal shape including at least three sides, and wherein at least one of the at least three sides is spaced apart from the boundary of the viewable area.

Embodiment 27. The glazing or electrochromic device of any one of the preceding embodiments, wherein the tintable area comprises a border having a rectangular shape defining four sides, and wherein one side of the border is spaced apart from the boundary of the viewable area, two sides of the border are spaced apart from the boundary of the viewable area, three sides of the border are spaced apart from the boundary of the viewable area, or wherein four sides of the border are spaced apart from the boundary of the viewable area.

Embodiment 28. The glazing or electrochromic device of any one of the preceding embodiments, wherein the boundary of the viewable area has a polygonal shape including at least three sides, and wherein a border of the tintable area is spaced apart from at least 10% of at least one of the at least three sides, at least 20% of at least one of the at least three sides, at least 30% of at least one of the at least three sides, at least 40% of at least one of the at least three sides, at least 50% of at least one of the at least three sides, at least 75% of at least one of the at least three sides, or at least 99% of at least one of the at least three sides.

Embodiment 29. The glazing or electrochromic device of any one of the preceding embodiments, wherein the boundary of the viewable area has a polygonal shape including at least three sides, and wherein a border of the tintable area is entirely spaced apart from at least one of the at least three sides, at least two of the at least three sides, or at least three of the at least three sides.

Embodiment 30. The glazing or electrochromic device of any one of embodiments 1-25, wherein the tintable area comprises a border having at least one straight side extending along a first line, wherein the boundary of the viewable area has at least one straight side extending along a second line, and wherein the first and second lines intersect.

Embodiment 31. The glazing or electrochromic device of any one of embodiments 1-25, wherein the tintable area comprises a border having an at least partially arcuate shape, wherein the border is entirely arcuate.

Embodiment 32. The glazing or electrochromic device of any one of embodiments 1-25 and 31, wherein the tintable area comprises a border having a length, L_{B}, and wherein at least 1% of L_{B} is arcuate, at least 5% of L_{B} is arcuate, at least 10% of L_{B} is arcuate, at least 25% of L_{B} is arcuate, at least 50% of L_{B} is arcuate, at least 75% of L_{B} is arcuate, or at least 99% of L_{B} is arcuate.

Embodiment 33. The glazing or electrochromic device of any one of the preceding embodiments, wherein the glazing is substantially free of a second electrochromic device, wherein the glazing is free of a second electrochromic device.

Embodiment 34. A method of making a glazing comprising:
providing a substrate having a viewable area contained within a boundary; and
forming an electrochromic device having a tintable area in the viewable area,
wherein the tintable area has a border, and wherein at least a portion of the border of the tintable area is spaced apart from the boundary of the viewable area.

Embodiment 35. A method of making a glazing comprising:
providing a substrate having a viewable area contained within a boundary; and
forming an electrochromic device having a tintable area;
wherein at least 1% of a border of the tintable area is spaced apart from the boundary of the viewable area.

Embodiment 36. The method of any one of embodiments 34 and 35, wherein at least 1% of the border of the tintable area is spaced apart from the boundary of the viewable area, at least 5% of the border of the tintable area is spaced apart from the boundary of the viewable area, at least 10% of the border of the tintable area is spaced apart from the boundary of the viewable area, at least 25% of the border of the tintable area is spaced apart from the boundary of the viewable area, at least 50% of the border of the tintable area is spaced apart from the boundary of the viewable area, at least 75% of the border of the tintable area is spaced apart from the boundary of the viewable area, or at least 99% of the border of the tintable area is spaced apart from the boundary of the viewable area.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A glazing comprising:
a substrate having a viewable area contained within a boundary; and
an electrochromic device coupled to the substrate,
wherein the electrochromic device has a tintable area spaced apart from the boundary of the viewable area along at least 5% of the boundary.

2. A glazing comprising:
a substrate having a viewable area contained within a boundary; and
an electrochromic device coupled to the substrate,
wherein the electrochromic device has a tintable surface area, A_{ED}, as defined by a tintable area contained within the boundary of the viewable area, the viewable area of the substrate has a surface area, A_{VA}, and wherein A_{ED} is less than A_{VA}.

3. The glazing of claim 1,
wherein a central portion of the viewable area comprises a number of layers of material, wherein a peripheral portion, adjacent to the boundary, comprises a number of layers of material, and wherein the number of layers at the central portion is greater than the number of layers at the peripheral portion.

4. The glazing of claim 1,
wherein the boundary defines an upper side segment, a lower side segment, a left side segment, and a right side segment; and
the electrochromic device has a tintable area spaced apart from at least one of the upper, lower, left, and right side segments.

5. The glazing of claim 1,
wherein the tintable area of the electrochromic device is contained entirely within the viewable area, wherein the tintable area is adapted to transition between a bleached state and a tinted state, and wherein in each of the bleached and tinted states all of tintable area has a substantially uniform characteristic.

6. The glazing of claim 1, wherein at least a portion of a border of the tintable area is spaced apart from the boundary of the viewable area by a distance of at least 0.5 cm.

7. The glazing of claim 6, wherein the distance between the border of the tintable area and the boundary of the viewable area is generally uniform as measured around the boundary of the viewable area.

8. The glazing of claim 6, wherein the distance between the border of the tintable area and the boundary of the viewable area comprises a first distance at a first location of the glazing and a second distance at a second location of the glazing, and wherein the first distance is different than the second distance.

9. The glazing of claim 8, wherein the first distance is greater than the second distance.

10. The glazing of claim 1, wherein the border of the tintable area is spaced apart from a boundary of the viewable area along at least 50% of the border of the tintable area.

11. The glazing of claim 2, wherein A_{VA} is at least 1.01 A_{ED}.

12. The glazing of claim 3, wherein the central portion has at least 2 more layers than the peripheral portion.

13. The glazing of claim 1, wherein the electrochromic device comprises:
an electrochromic layer;
a counter electrode layer; and
an ion conductive layer disposed between the electrochromic layer and the counter electrode layer.

14. The glazing of claim 1, wherein the electrochromic device is a solid state device.

15. The glazing of claim 1, wherein the tintable area comprises a border having a polygonal shape including at least three sides, and wherein at least one of the at least three sides is spaced apart from the boundary of the viewable area.

16. The glazing of claim 1, wherein the tintable area comprises a border having a rectangular shape defining four sides, and wherein one side of the border is spaced apart from the boundary of the viewable area.

17. The glazing of claim 1, wherein the tintable area comprises a border having an at least partially arcuate shape.

18. The glazing of claim 1, wherein the glazing is free of a second electrochromic device.

19. A method of making a glazing comprising:
providing a substrate having a viewable area contained within a boundary; and
forming an electrochromic device having a tintable area in the viewable area,
wherein the tintable area has a border, and wherein at least a portion of the border of the tintable area is spaced apart from the boundary of the viewable area.

20. The method of claim 19, wherein at least 1% of the border of the tintable area is spaced apart from the boundary of the viewable area.
